(19) United States
(12) Patent Application Publication
(10) Pub. No.: US 2010/0007730 A1
(43) Pub. Date: Jan. 14, 2010

(54) Surveillance Display Apparatus, Surveillance System, and Control Method Thereof

(76) Inventor: Meng-Te LIN, Pa Te City (TW)

Correspondence Address: TROXELL LAW OFFICE PLLC;SUITE 1404, 5205 LEESBURG PIKE, FALLS CHURCH, VA, 22041, US

(21) Appl. No.: 12/170,187

(22) Filed: Jul. 9, 2008

(51) Int. Cl. H04N 7/18

(52) U.S. Cl. 348/143; 348/E07.085

(57) ABSTRACT

The present invention discloses a surveillance display apparatus including a touch control area or a control area with a graphical user interface (GUI) for adjusting a monitored image, and the surveillance display apparatus receives the monitored image captured by different image capturing devices (such as a digital video recorder and a video switch, etc), and uses the graphical user interface to control or adjust each monitored image, and improve the traditional adjusting or control method that requires a special keyboard controller.

### BACKGROUND OF THE INVENTION

(a) Field of the Invention

The present invention relates to a surveillance display apparatus and a surveillance system, and more particularly to a surveillance display apparatus and a surveillance system providing users a graphical user interface (GUI) to adjust a video surveillance by a touch control and improve the traditional way of adjusting or controlling the apparatus and system by a keyboard or a mouse, and the invention provides a better and simpler operating mode for the surveillance display apparatus and the surveillance system.

(b) Description of the Prior Art

As science and technology advance rapidly, a surveillance system has become a part of protecting the safety of our life. A surveillance system generally captures a series of images of a scene by a plurality of cameras, and a digital video recorder (DVR) receives the series of image taken by the cameras. The digital video recorder processes a compression/decompression by digital technology, not only extending the recording time, but also solving the signal attenuation problem of the recording tape. In addition, users can rewind the recording tape and search a captured screen according to a parameter such as date, time, camera and alarm record. Particularly, the “displacement detection” function of the digital video recorder provides a precise security control according to a displacement detection area set for each camera. Further, the DVR can be connected to the Internet for transmitting a digital video signal via the Internet, so that a user at a remote end can monitor a scene timely through a computer browser Related setups and operations are the same as those for the operation of a computer system, and the user can control information regarding the security of a monitoring site.

A traditional surveillance system includes a plurality of cameras, a digital video recorder, a computer, a screen, a mouse and a keyboard, and the computer retrieves a series of images captured by the camera from the digital video recorder continuously and controls the series of image captured by the camera, and controls the screen to display the series of images on a monitoring screen, Further, users can use a keyboard or a mouse to adjust the size, contrast, color and brightness of a monitored screen or switch a monitoring screen to display a series of images captured by another camera.

However, the way of using a keyboard or mouse for making the adjustment still has the following drawbacks:

1. The keyboard or mouse is a separate device which occupies some space and causes inconvenience to carry.

2. The keyboard comes with a limited space for accommodating the control keys, and thus the keyboard cannot cope with various different types of cameras.

### SUMMARY OF THE INVENTION

The primary objective of the present invention is to overcome the shortcomings of the prior art by providing a surveillance display apparatus and a surveillance system allowing user to use a graphical user interface and a touch control method to adjust a monitored image through a simple and easy operating mode and improve the prior art that requires a keyboard or mouse for the adjustment or control.

To achieve the foregoing objective, the present invention provides a surveillance display apparatus comprising a touch control area or a control area with a graphical user interface (GUI) for adjusting a monitored image, and the surveillance display apparatus is capable of receiving monitored images captured by various different image capturing devices (such as a digital video recorder and a video switch, etc), and using the graphical user interface to control or adjust each monitored image, and improve the prior art that requires a special keyboard controller for the adjustment or control.

### BRIEF DESCRIPTION OF THE DRAWINGS

FIG. 1 is a schematic view of a surveillance display apparatus applied in a surveillance system in accordance with a first preferred embodiment of the present invention;

FIG. 2 is a schematic view of a surveillance display apparatus in accordance with the present invention;

FIG. 3 is a schematic view of a surveillance display apparatus applied in a surveillance system in accordance with a second preferred embodiment of the present invention; and

FIG. 4 is a schematic view of a surveillance display apparatus applied in a surveillance system in accordance with a third preferred embodiment of the present invention.

### DETAILED DESCRIPTION OF THE PREFERRED EMBODIMENTS

In the surveillance display apparatus and the surveillance system in accordance with the present invention, the surveillance display apparatus comprises a touch control area or a control area with a graphical user interface for adjusting the monitored image, and users can use the touch control method or other control device (such as a mouse) to select an option on the graphical user interface to adjust the monitored image, so as to improve the traditional way of using a specific keyboard controller for the adjustment or control.

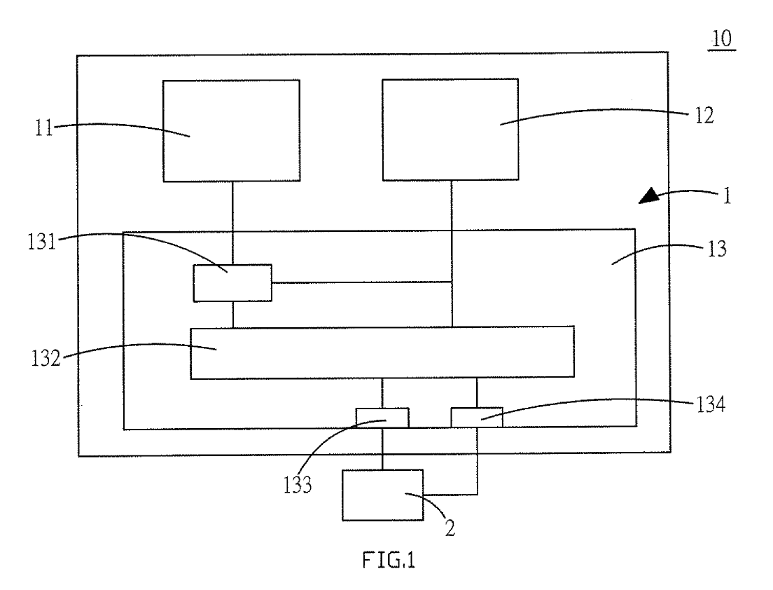

With reference to FIG. 1 for a schematic view of a surveillance display apparatus 1 applied in a surveillance system 10, the surveillance display apparatus 1 comprises:

an image display area 11;

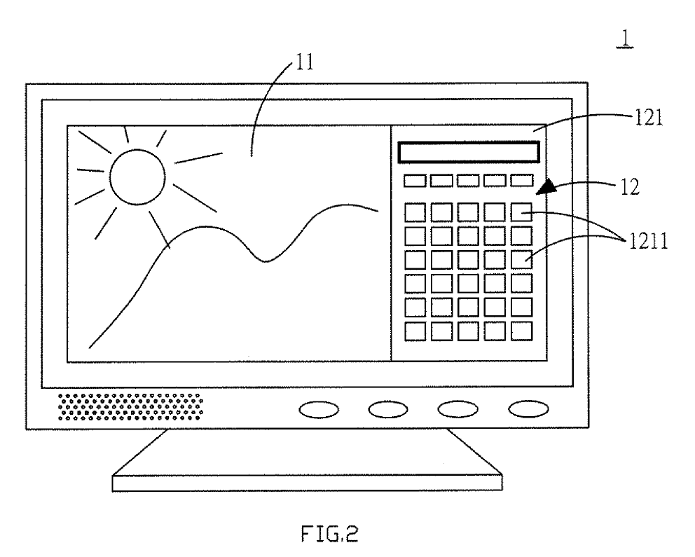

a touch control area 12, disposed at an area not overlapped with the image display area 11 as shown in FIG. 2, wherein the surveillance display apparatus 1 has an aspect ratio of 16:10 or 16:9, and the touch control area 12 is a touch control screen integrated in the surveillance display apparatus 1 and disposed on a left side of the image display area 11, and the touch control area 12 displays a graphical user interface 121;

a video controller 13, including an on-screen display (OSD) control unit 131, a control unit 132 and at least one image receiving port 133, wherein the on-screen display control unit 131 and the image receiving port 133 are coupled to the control unit 132 separately, and the on-screen display control unit 131 controls the display characteristics such as position, size and fonts of the graphical user interface 121 and the position of the touch control area disposed on a left side or a right side of the image display area to meet the using habits of different users (including left-handed and right-handed users)

In the preferred embodiment of the invention, the video controller 13 comprises a single image receiving port 133 and a transmission control unit 134, and the image receiving port 133 is coupled to an image capturing device 2 for retrieving the images, and the transmission control unit 134 is coupled to the control unit 132 to constitute the connection of the control unit 132 and the image capturing device 2, and the transmission control unit 134 is a RS485 interface, and the control unit 132 controls the image capturing device 2 through the transmission control unit 134.

During use, the surveillance display apparatus 1 receives a monitored image retrieved by image capturing device 2 through the image receiving port 133 to constitute the surveillance system 10, and the control method of the surveillance display apparatus comprises the following steps:

Step A: The on-screen display control unit 131 overlaps the monitored image with the graphical user interface 121 and transmits the monitored image to the surveillance display apparatus 1 to display the monitored image (as shown in FIG. 2), and the image display area 11 displays the monitored image, and the touch control area 12 displays the graphical user interface 121, wherein the graphical user interface 121 can control the monitored image received by the image receiving port 133, and the graphical user interface 121 includes a plurality of control blocks 1211.

Step B: A user touches the touch control area. If the user wants to adjust the monitored image, the user searches a desired adjusting option (such as the size, contrast, color or brightness of the monitored image) from the graphical user interface 121 displayed in the touch control area 12 and touches the control block 1211 according to a touch control method.

Step C: The control unit 132 compares the touch control position with a corresponding control code produced by the on-screen display control unit 131.

Step D: The control code is transmitted by the transmission control unit 134 to the image capturing device 2, and the monitored image is formed to a corresponding adjusted status according to the control code.

Step E: The on-screen display control unit 131 transmits the adjusted monitored image to the image display area 11 for its display.

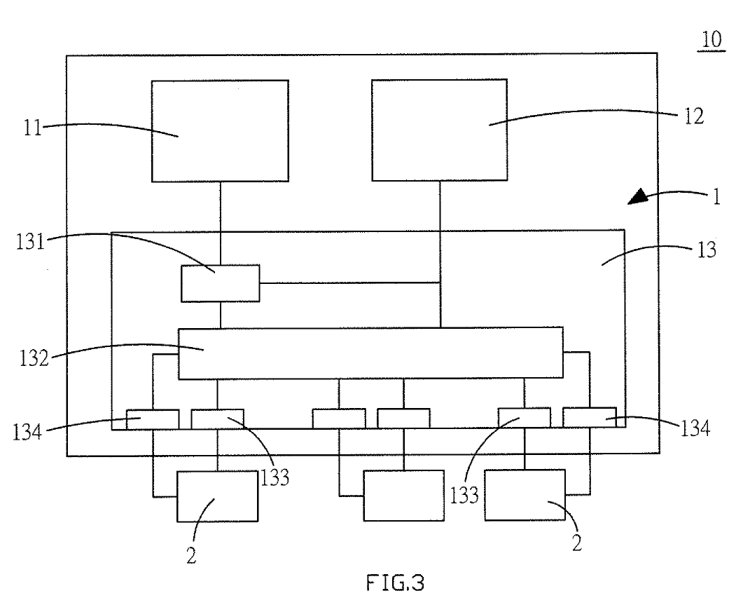

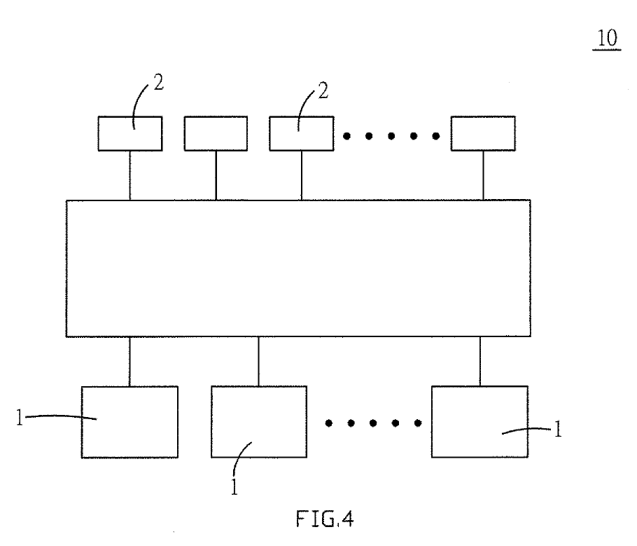

With reference to FIG. 3 for a surveillance display apparatus applied in a surveillance system in accordance with a second preferred embodiment of the present invention, the surveillance system 10 comprises a surveillance display apparatus 1 and a plurality of image capturing devices 2, and each image capturing device 2 is coupled to the surveillance display apparatus 1, and the image capturing device 2 is a digital video recorder (DVR), a close circuit television (CCTV) or a video switch etc. The surveillance system 10 further comprises a matrix controller 3 as shown in FIG. 4, and the matrix controller 3 is coupled to a plurality of surveillance display apparatuses 1 and image capturing devices 2.

In use, the graphical user interface 121 includes a plurality of control blocks 1211, each corresponding to an image capturing device 2 connected to each image receiving port 133 and has a different control block 1211, and each image capturing device 2 forms a sub control block (not shown in the figure). If a user wants to switch the monitored image of each image capturing device 2, the user also finds a desired option (such as switching to the monitored image of a digital video recorder (DVR), a close circuit television (CCTV) or a video switch) from the graphical user interface 121 displayed in the touch control area 12 and touches the control block 1211 according to the touch control method. Now, the control unit 132 compares the touch control position with a corresponding control code produced by the on-screen display control unit 131, and the control code is transmitted to the image capturing device 2 through the transmission control unit 134, and the monitored image of the image capturing device 2 is received, and the on-screen display control unit 131 transmits the monitored image to the image display area 11 for its display. The method of adjusting the monitored image is the same as described above. Similarly, the monitored image in the touch control area transmitted from the image receiving port is adjusted by the control unit.

Further, the graphical user interface of the surveillance display apparatus is provided used to replace the control by a mouse by the touch control method.

Compared with the prior art, the present invention has the following advantages:

1. The present invention integrates the apparatus for controlling and adjusting an image with a display device. In other words, the invention uses a graphical user interface to adjust a monitored image, not only provides a simple and easy operation to users, but also reduces the occupying space.

2. The graphical user interface may come with different control blocks, and the quantity of control blocks can be increased or decreased freely according to the characteristics of different image capturing devices.

3. The touch control area copes with the using habit of right-handed or left-handed users by displaying the graphical user interface on the left side or right side of the surveillance display apparatus respectively to enhance the practicability of the invention.

In summation of the above description, the surveillance display apparatus and surveillance system in accordance with the present invention herein enhances the performance than the conventional structure and further complies with the patent application requirements and is thus duly filed for patent application. While the invention has been described by means of specific embodiments, numerous modifications and variations could be made thereto by those skilled in the art without departing from the scope and spirit of the invention set forth in the claims.

I claim:

1. A surveillance display apparatus, comprising:
an image display area;
a touch control area, disposed at an area not overlapped with the image display area, for displaying a graphical user interface; and
a video controller, including on-screen display control unit, a control unit and at least one image receiving port, and the on-screen display control unit and the image receiving port being coupled to the control unit separately, and the touch control area adjusting a monitored image transmitted from the image receiving port by the control unit;
such that a control code obtained from the transmission control unit, the touch control area and the on-screen display control unit is transmitted to the image capturing device.

2. The surveillance display apparatus of claim 1, wherein the touch control area is a touch control screen integrated with the surveillance display apparatus.

3. The surveillance display apparatus of claim 1, wherein the surveillance display apparatus has an aspect ratio of 16:10 or 16:9.

4. The surveillance display apparatus of claim 1, wherein the touch control area is disposed on a left side or a right side of the image display area.

5. The surveillance display apparatus of claim 1, wherein the graphical user interface is capable of controlling a monitored image received from an image receiving port.

6. The surveillance display apparatus of claim 1, wherein the on-screen display control unit is provided for overlapping the monitored image with the graphical user interface and transmitting the monitored image to the image display area to display the monitored image.

7. The surveillance display apparatus of claim 1, wherein the on-screen display control unit controls the display characteristics of the graphical user interface.

8. The surveillance display apparatus of claim 1, wherein the video controller further comprises a transmission control unit coupled to the control unit.

9. The surveillance display apparatus of claim 8, wherein the transmission control unit is a RS485 interface.

10. A surveillance system, comprising:
a surveillance display apparatus of claim 1;
a plurality of image capturing devices, each coupled to the surveillance display apparatus, for transmitting the captured monitored image to the surveillance display apparatus.

11. The surveillance system of claim 10, wherein the surveillance system further comprises a matrix controller, a digital video recorder (DVR), a video switch or a close circuit television (CCTV).

12. The surveillance system of claim 11, wherein the matrix controller is coupled to a plurality of surveillance display apparatuses and image capturing devices.

13. The surveillance system of claim 10, wherein the video controller further comprises a transmission control unit that couples the control unit with each image capturing device.

14. The surveillance system of claim 13, wherein the transmission control unit is a RS485 interface.

15. A control method of a surveillance system, and the surveillance display apparatus being coupled to at least one image capturing device, and the surveillance display apparatus including an image display area, a touch control area and a video controller, and the video controller including an on-screen display control unit, control unit, and at least one image receiving portend transmission control unit, and the method comprising the steps of:
the on-screen display control unit overlapping a monitored image with a graphical user interface and transmitting the monitored image to the surveillance display apparatus to display the monitored image in the image display area and a graphical user interface in the touch control area;
a user touching the touch control area;
the control unit comparing the touch control position with a control code produced by the on-screen display control unit;
transmitting the control code to the image capturing device through the transmission control unit, and forming the monitored image in a corresponding adjusted status according to the control code; and
the on-screen display control unit transmitting an adjusted monitored image to the image display area to display the monitored image.

16. The control method of a surveillance display apparatus of claim 15, wherein the touch control area is a touch control screen integrated with the surveillance display apparatus.

17. The control method of a surveillance display apparatus of claim 15, wherein the surveillance display apparatus has an aspect ratio of 16:10 or 16:9.

18. The control method of a surveillance display apparatus of claim 15, wherein the graphical user interface controls a monitored image received by the image receiving port.

19. The control method of a surveillance display apparatus of claim 15, wherein the on-screen display control unit is provided for overlapping the monitored image with the graphical user interface and transmitting the monitored image to the image display area to display the monitored image.

20. The control method of a surveillance display apparatus of claim 15, wherein the on-screen display control unit controls the display characteristics of the graphical user interface.
